(19) United States
(12) Patent Application Publication
(10) Pub. No.: US 2015/0246569 A1
(43) Pub. Date: Sep. 3, 2015

(54) Graph Paper

(71) Applicant: Amber Leet, Waltham, MA (US)

(72) Inventor: Amber Leet, Waltham, MA (US)

(21) Appl. No.: 14/484,075

(22) Filed: Sep. 11, 2014

Related U.S. Application Data
(60) Provisional application No. 61/877,050, filed on Sep. 12, 2013.

(51) Int. Cl. B42D 15/00

(52) U.S. Cl. CPC B42D 15/0006

(57) ABSTRACT

A graph paper is provided that is adapted to prevent transfer of construction lines from an original sheet to a copied sheet when using a photocopier or scanner. The graph paper comprises one or more sheets having grid lines in a grid pattern thereon. The lines are printed such that they comprise a similar grayscale value with respect to the page grayscale color. The difference between grid line grayscale value and the page grayscale value are such that a photocopy machine or a scanner will not readily register the lines when transferring the images of the page, and therefore will not readily transfer the grid pattern from the original page to a copy or reproduced image. The graph paper is therefore adapted for use when taking hand calculations or notes by hand, whereafter the writing can be reproduced without the clutter of the grid lines being transferred when copied or scanned.

### CROSS REFERENCE TO RELATED APPLICATION

This application claims the benefit of U.S. Provisional Application No. 61/877,050 filed on Sep. 12, 2013. The above identified patent application is herein incorporated by reference in its entirety to provide continuity of disclosure.

### BACKGROUND OF THE INVENTION

1. Field of the Invention

The present invention relates to graph paper products and lined paper adapted to be photocopied without transferring the underlying lines. More specifically, the present invention relates to a graph paper having a grid pattern comprised of a color chosen such that the grayscale value difference between the paper color and the line color is of sufficiently low, thereby minimizing the ability of a black and white photocopy machine from transferring the grid lines from the original page to a reproduced copy.

Graph paper is a common item used for taking notes, working through hand calculations and plotting items on a page. Paper of this type generally comprises a surface having a grid pattern thereon, wherein the user can create plots and graphs using appropriate scaling. Each block within the graph is given a unit of measure such that a plot or graph can be created by hand in scale. Paper of this type is well known in the scientific and engineering fields, where a user may create a plot by hand to track measurements or data, and may also wish to neatly work through a calculation. The lines of the graph paper are both vertical and horizontal, providing a means to organize calculations and place items in an ordered arrangement for subsequent printing or display.

One common drawback of paper of this type is that reproduction of the hand-drawn plot or calculations is difficult to accomplish without also transferring the graph paper construction lines. During the reproduction process, the graph lines are generally transferred to the newly created copy. The transferred graph lines may not be desired by the user. Many students and professionals use graph paper for clarity and precision during preliminary work, and may wish to subsequently use the hand-sketched data directly in presentation or handout. Unfortunately, when making copies, the graph paper lines create a distracting gridline pattern that transfers to the copies, making them look clustered, sloppy, and unprofessional.

The present invention discloses a new graph paper construction that provides a writing surface having a grid pattern disposed thereon that is selected from a color palette adapted to exhibit minimal difference between the paper stock material color and the printed lines of the grid. The minimal difference allows the writing user to visualize the faint grid lines on the paper, whereafter the paper can be copied or reproduced without duplicating the pattern in the resulting copy. The contrast is such that a standard photocopier or scanner will not readily distinguish between the paper color and the grid color, thereby preventing it from being transposed from the original copy to the reproduced copy.

Specifically, the lines of the graph construction lines and the color of the paper free field area are presented in greyscale, whereby the three dimensions of color (hue, saturation, and lightness) are converted to grayscale and reduced to a single dimension (grayscale value). White is referenced as 100% and pure black is 0% grayscale value. The present graph paper comprises a paper with construction lines having a grayscale value such that reproduction on a black and white photocopier or scanner will not readily transfer the construction lines to the reproduced copy. Therefore, the reproduced copy transfers only the markings of the user, and the graph paper construction lines are indistinguishable from the free field area of the paper.

2. Description Of The Prior Art

Devices have been disclosed in the prior art that relate to graph paper and transferring images from one medium to another. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

Much of the art relates to methods for transferring images from one medium to another, or for facilitating drafting of an image based on projected gridlines. Other devices in the art relate to various paper products that facilitate capturing hand-drawn or copied images thereon. The present invention relates to a new paper product that provides a user with graph paper to create plots, drawings, and writings that are aligned and properly proportioned, if so desired. Furthermore, the present invention allows a user to hand-draw items on the paper and thereafter photocopy or scan the paper for the purposes of transferring the image to a digital form or for reproducing the hand-drawn items. The graphing lines of the paper are provided such that their grayscale value relative to the rest of the paper is minimized, thereby minimizing the ability of a photocopy machine or scanner to transfer the graphing lines.

Overall, the present invention substantially diverges in design elements from the prior art, and consequently it is clear that there is a need in the art for an improvement to existing graph paper products. In this regard the instant invention substantially fulfills these needs.

### SUMMARY OF THE INVENTION

In view of the foregoing disadvantages inherent in the known types of graph paper construction now present in the prior art, the present invention provides a new graph paper product and method of production that can be utilized for providing convenience for the user when transferring writings graphing paper without transferring the construction lines.

It is therefore an object of the present invention to provide a new and improved graph paper product that has all of the advantages of the prior art and none of the disadvantages.

It is another object of the present invention to provide a graph paper that supports writing in pen, pencil or marker, and further provides a grid work of construction lines for scaled drawings, plots, and the like.

Another object of the present invention is to provide a graph paper whose construction lines are very similar to the free field area of the paper in terms of grayscale value, whereby the construction lines do not as readily transfer to a reproduced copy after being scanned by a photocopier or scanner device.

Yet another object of the present invention is to provide construction lines on a graph paper that are in grayscale, whereby the difference in grayscale value of the paper and the grayscale construction lines are minimized to prevent transference during photocopying or scanning.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a representative view of a sheet of the graph paper of the present invention.

### DETAILED DESCRIPTION OF THE INVENTION

Reference is made herein to the attached drawings. Like reference numerals are used throughout the drawings to depict like or similar elements of the graph paper of the present invention. For the purposes of presenting a brief and clear description of the present invention, the preferred embodiment will be discussed as used for creating plots, drawings, and making notes on a paper having construction lines that will not transfer when copied. The figures are intended for representative purposes only and should not be considered to be limiting in any respect.

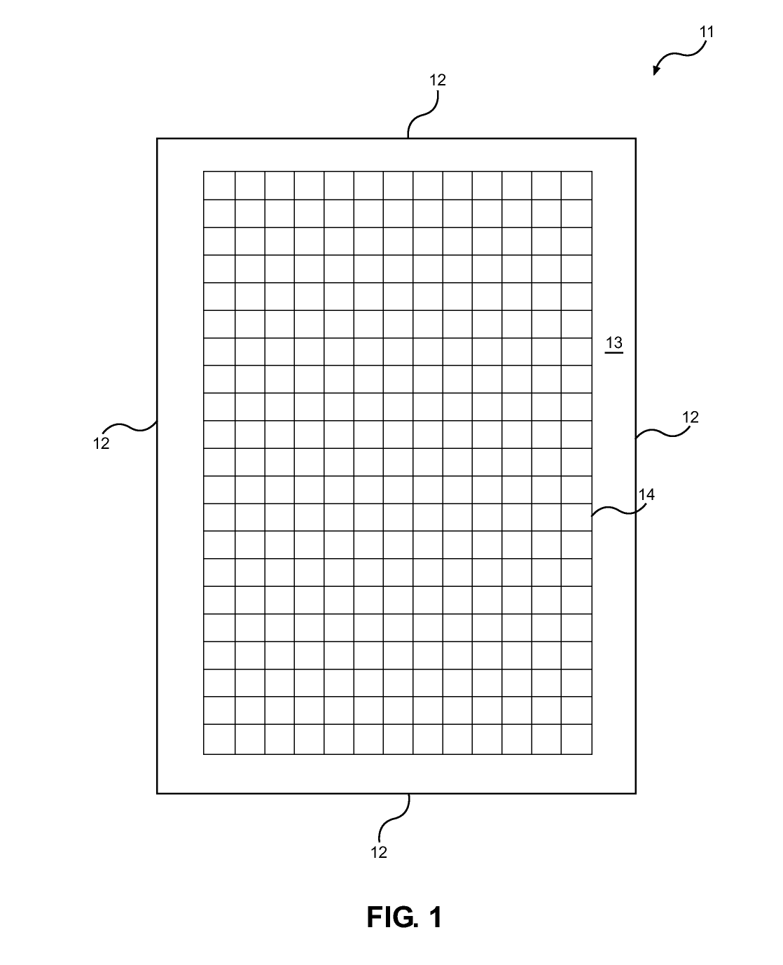

Referring now to FIG. 1, there is shown a view representative of the graph paper 11 of the present invention. The graph paper comprises a paper product comprising an upper surface, a lower surface, and a plurality of side edges 12. At least one of the surfaces 13 includes a plurality of construction lines 14 thereon. The construction lines 14 for a grid pattern preferably in the form of small squares, whereby each square has the same size across the entire grid.

The construction lines 14 of the graph paper 11 are preferably printed in grayscale, whereby the construction lines are a shade of gray and a combination of black and white ink. Color can be defined by hue (0°-360°, saturation (0%-100%) and lightness (0%-100%). The present invention contemplates a grayscale printing method in which the difference in construction lines and the paper is measured in terms of grayscale value of the two, rather than by color differences. The grayscale value between the construction lines and the paper free field area is minimized to a degree that the lines are visible when writing, yet not readily transferred upon photocopying and scanning. Grayscale is mapped to one dimension (grayscale value), wherein white=100% and black=0%. Specifically, the lines and the paper grayscale value are within 20% lightness of one another. The user can register the faint construction lines while writing, yet the lines are indistinguishable from the paper's otherwise uniform field when photocopied or scanned.

The disclosed method of producing graph paper involves choosing a grid pattern for construction lines to be printed on a paper. Choosing a grayscale color having a defined value for the paper, and then limiting the grayscale value of the construction lines to within 20% grayscale thereof. The construction lines are then printed on paper having a paper color in grayscale. The difference in grayscale value between the lines and the paper makes the lines disappear when the paper is photocopied or scanned. This enables a user to create precise work without graph lines being visible in a reproduction copy thereof. The present invention enables the creation of clear and precise work usable construction lines, whereafter the work can be copied without visible construction lines. Graph paper generally improves overall neatness and precision while writing or creating charts, while the ability to copy the work without reproducing the construction lines assists with clarity and subsequent presentation of the work.

The present invention describes a means of manufacturing graph paper. The method involves the printing of construction lines on standard 4-count and 8-count paper. The construction lines are printed in grayscale on a grayscale paper (non-colored paper). The difference in grayscale value of the construction lines and the paper is maintained within a small window to prevent transference when copying the paper after markings have been applied by the user. The construction lines may be disposed in various formats, including logarithmic scaling, hexagonal, and isometric graph paper. The similar grayscale values of the lines and the paper allow the lines to seemingly disappear when the paper is photocopied.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of producing graph paper to reduce transference of construction lines when photocopied or scanned, comprising the steps of:
choosing construction lines having a grid pattern;
choosing a paper color in grayscale, said paper color having a grayscale value between 0 and 100 percent;
choosing a construction color in grayscale, said construction color having a grayscale value between 0 and 100 percent and closely related to said paper color so as to minimize visual differences between said construction color and said paper color;
printing said construction lines in said construction color on a writable material of said paper color.

2. The method of claim 1, wherein said construction color further comprises a grayscale value within 20 percent of said paper color.
